(19) United States
(12) Patent Application Publication
(10) Pub. No.: US 2007/0123675 A1
(43) Pub. Date: May 31, 2007

(54) Sheet polarizer, optical film, liquid crystal display, and method of producing sheet polarizers

(75) Inventors: Yoji Ito, Kanagawa (JP); Yukio Shinagawa, Kanagawa (JP); Ichiro Amimori, Kanagawa (JP); Keiichi Taguchi, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJI PHOTO FILM CO., LTD.

(21) Appl. No.: 11/600,890

(22) Filed: Nov. 17, 2006

Related U.S. Application Data
(62) Division of application No. 10/660,599, filed on Sep. 12, 2003.
Application No. 10/660,599 is a division of application No. 09/716,258, filed on Nov. 21, 2000, now abandoned.

(30) Foreign Application Priority Data
Nov. 22, 1999 (JP) P. HEI. 11-331569
Mar. 31, 2000 (JP) P. 2000-98570
May 25, 2000 (JP) P. 2000-154877

(51) Int. Cl. B05D 5/06; B05D 3/12; C08F 118/02

(52) U.S. Cl. 526/319; 427/162; 427/171

(57) ABSTRACT

An optical film formed by a method comprising stretching a film comprising a polyvinyl alcohol or a modified polyvinyl alcohol at an oblique angle ranging from 10 to 80 degrees to the machine direction of the film.

### CROSS-REFERENCE TO RELATED APPLICATIONS

This application is a divisional of application Ser. No. 10/660,599, filed Sep. 12, 2003, which is a divisional of application Ser. No. 09/716,258, filed Nov. 21, 2000, now abandoned, the contents of which applications are incorporated herein by reference.

### FIELD OF THE INVENTION

The present invention relates to extremely thin sheet polarizers and a method of producing the sheet polarizers in a very high yield factor, which is characterized by adoption of the orientation technique utilizing a rubbing operation and not a current stretching operation.

Further, the invention is concerned with an obliquely stretched polyvinyl alcohol film, a sheet polarizer comprising such a film, and a liquid crystal display using such sheet polarizers.

### BACKGROUND OF THE INVENTION

Hitherto, sheet polarizers used in a liquid crystal display (hereinafter abbreviated as “LCD”) have been prepared in the following manner:

A polarizing element is produced by the use of a method of dissolving or adsorbing dichroic molecules, such as iodine or dyes, in or to a high molecular substance as an orientation e.g., polyvinyl alcohol (hereinafter abbreviated as “PVA”) and then stretching a film made of the dichroic molecules-incorporated high molecular substance in one direction to align the dichroic molecules, or a method of adsorbing the foregoing dichroic molecules to a monoaxially stretched film of high molecular substance, such as PVA, and then the polarizing element is sandwiched between protective films made of, e.g., triacetyl cellulose (hereinafter abbreviated as “TAC”), thereby providing a sheet polarize.

Those methods necessitate the stretching of an orientation controller in order to align dichroic molecules. Therefore, they are under restrictions, e.g., such that nothing but sheet polarizers oriented in one direction alone can be produced thereby.

In the case of using a stretched film, the film has an additional restriction on thickness. Usually, the film having a thickness of about 30 μm after stretching is employed.

By contrast, as disclosed, e.g., in JP-A-7-261024 (the term “JP-A” as used herein means an “unexamined published Japanese patent application”), it has recently been known that the sheet polarizers requiring no stretching operation at all and having an arbitrary polarization axis were produced by forming a dichroic molecular layer on a layer comprising optically active molecules provided on a substrate. Therein, however, the dichroic molecules are oriented in a particular direction through irradiation with light, so that the time required for alignment of molecules is too long. Accordingly, such a method is impractical for continuous processing of a long sheet. In addition, such sheet polarizers have poor in-plain uniformity. Further, their efficiency of polarization is too low to be put to practical use, as compared with that of the conventional sheet polarizer.

On the other hand, the method of rubbing in one direction a glass surface or a high molecular film surface with cloth or paper and then adsorbing dichroic molecules to the rubbed surface has been reported in J. F. Dreyer, Journal of Phys. Colloid Chem., page 52, 808 (1948). However, this reference has no description of continuous processing of long-sheet materials, and suffers from a problem that the high molecular film oriented by rubbing causes relaxation under high temperature and high humidity to disturb the alignment of dichroic molecules; as a result, the efficiency of polarization is lowered.

In every conventional LCD, the transmission axis of a sheet polarizer is arranged so as to form an angle of 45 degrees with the longitudinal or transverse direction of the screen. In the stamping process of a sheet polarizer produced in a roll form, it is therefore required to perform the stamping operation in the 45-degree direction. This 45-degree stamping eventually gives rise to useless areas in the edge part of the roll; as a result, the yield rate is lowered.

In recent years, liquid crystal displays have advanced in thickness and weight reductions, and all members of the display have been miniaturized and reduced in thickness and weight. Although various attempts as mentioned above have been made in line with such a trend, no sheet polarizer capable of taking the place of conventional ones in terms of performance is developed yet.

Further, conventional methods for producing long sheet polarizers have a drawback of being very low in their yield factors. A reason for the inferiority in yield factor is as follows: As mentioned above, every conventional method can only make PVA orient in the longitudinal or transverse direction of the film, so that the sheet polarizer produced always comes to have a polarizing axis parallel or perpendicular to the longitudinal direction. For sticking on a liquid crystal display, however, it is necessary to stamp out rectangular chips of sheet polarizer so that they have their individual polarizing axes in the direction of 45 degrees. Therefore, it has been awaited to solve the foregoing problems.

### SUMMARY OF THE INVENTION

Objects of the invention are to improve a yield rate in the stamping process of a sheet polarizer, and to produce a high-performance sheet polarizer at a low price by the use of a simple method.

As a result of our intensive studies in view of these circumstances, we have achieved the present invention. More specifically, the problems of the invention is resolved by the following Embodiments (1) to (20):

(1) A sheet polarizer having a great length, wherein the sheet polarizer has a transmission axis neither parallel nor perpendicular to the longitudinal direction.

(2) The sheet polarizer as described in Embodiment (1), comprising at least a transparent substrate and a polymer layer having a polarization capability, wherein the polymer layer has a cross-linked structure.

(3) The sheet polarizer as described in Embodiment (2), wherein the polymer layer is a layer comprising a polyvinyl alcohol or a modified polyvinyl alcohol.

(4) The sheet polarizer as described in Embodiment (3), with the polyvinyl alcohol or the modified polyvinyl alcohol has a saponification degree of at least 95%.

(5) The sheet polarizer as described in any of Embodiments (2) to (4), wherein the cross-linked structure is a structure formed by reaction between the polymer and a cross-linking agent.

(6) The sheet polarizer as described in Embodiment (5), wherein the cross-linking agent is a boric acid compound.

(7) The sheet polarizer as described in any of Embodiments (2) to (6), wherein the polymer layer further comprises iodine.

(8) The sheet polarizer as described in any of Embodiments (2) to (6), wherein the polymer layer further comprises a dichroic dye.

(9) A method of producing a sheet polarizer comprising a step of coating a long transparent substrate with a polymer layer, a step of subjecting the polymer layer to a rubbing treatment, and a step of adsorbing iodine or a dichroic dye to the rubbed polymer layer to bring about a state of orientation.

(10) A method of producing a sheet polarizer comprising a step of coating a long transparent substrate with a polymer layer containing iodine or a dichroic dye, and a step of subjecting the polymer layer to a rubbing treatment.

(11) The method of producing a sheet polarizer as described in Embodiment (9) or (10), wherein the polymer layer is a layer comprising a polyvinyl alcohol or a modified polyvinyl alcohol.

(12) The method of producing a sheet polarizer as described in Embodiment (11), wherein the polyvinyl alcohol or the modified polyvinyl alcohol has a saponification degree of at least 95%.

(13) The method of producing a sheet polarizer as described in any of Embodiments (9) to (12), wherein the rubbing treatment is carried out continuously by arranging a rubbing roll at an oblique angle to the direction in which a long film of the polymer layer-coated transparent substrate is made to travel and rubbing the polymer layer with the rubbing roll while moving the long film so as to wrap the rubbing roll.

(14) The method of producing a sheet polarizer as described in Embodiment (13), wherein the oblique angle at which the rubbing roll is arranged is 45 degrees to the direction in which the long film travels.

(15) A method of producing a sheet polarizer comprising a step of coating a long transparent substrate with a polymer layer made up of at least a modified polyvinyl alcohol, a step of rubbing the polymer layer in a direction neither parallel nor perpendicular to the longitudinal direction, and a step of adsorbing iodine or a dichroic dye to the rubbed polymer layer to bring about a state of orientation.

(16) A method of producing a sheet polarizer comprising a step of coating a long transparent substrate with a polymer layer made up of at least a modified polyvinyl alcohol in which iodine or a dichroic dye is contained, and a step of rubbing the polymer layer in a direction neither parallel nor perpendicular to the longitudinal direction.

(17) An optical film formed by comprising stretching a film comprising a polyvinyl alcohol or a modified polyvinyl alcohol at an oblique angle ranging from 10 to 80 degrees to the machine direction of the film.

(18) A sheet polarizer comprising two transparent substrates and a polarization layer sandwiched between them, wherein the polarization layer comprises a polyvinyl alcohol film stretched at an oblique angle ranging from 10 to 80 degrees and a polarizing element adsorbed to the film in an oriented state.

(19) The sheet polarizer as described in Embodiment (18), wherein at least one of the transparent substrates satisfies the following relations at any of wavelengths ranging from 380 nm to 780 nm:
−10≦(nx−ny)×d≦10
0≦{(nx+ny)/2−nz}×d≦40
wherein d represents a thickness of the transparent substrate, each n represents a refractive index, x represents the machine direction (referred to as MD direction also) of the transparent substrate, y represents the transverse direction (referred to as TD direction also) of the transparent substrate, and z represents the thickness direction of the transparent substrate.

(20) The liquid crystal display comprising a liquid crystal cell and two sheet polarizers arranged on both sides of the cell, wherein at least one of the two sheet polarizers is a sheet polarizer as described in Embodiment (18) or (19).

### BRIEF DESCRIPTION OF DRAWINGS

FIG. 1 shows the oblique angle of a rubbing roll and a wrap angle in the stage of rubbing treatment.

FIG. 2 shows conventional and present modes of making sheet polarizer chips from a long sheet polarizer.

FIG. 3 shows a case wherein an obliquely stretched polarization film and transparent substrates are united into a laminate by means of rolls (not shown).

FIG. 4 shows a case wherein a film is stretched at an angle of 45 degrees to the direction in which the film travels.

FIG. 5 shows a conventional case of stamping a long sheet polarizer into rectangular chips.

FIG. 6 shows a present case of stamping a long sheet polarizer into rectangular chips.

FIG. 7 shows a stamping mode (a) carried out in Examples 5 and 6, and a stamping mode (b) carried out in Comparative Example 1.

FIG. 8 shows a cross sectional view of LCD using wide viewing films produced in Example 7.

The reference numerals used in those figures have the following meanings respectively:
11 Transparent substrate
12 PVA film
13 MD direction
14 Absorption axis
21 PVA film
22 Tenter
23 Direction in which the film travels (MD direction)
24R Position at which different-speed stretching begins (on the right side)
24L Position at which different-speed stretching begins (on the left side)
25R Position at which different-speed stretching comes to an end (on the right side)
25L Position at which different-speed stretching comes to an end (on the left side)
26R Stretching speed on the right side
26L Stretching speed on the left side
31 Absorption axis (stretching axis)
32 MD direction
41 Absorption axis (stretching axis)
42 MD direction
43 Cut-off plane (slit position)
61 Iodine-containing polarization film (polarization layer)
62 Lower-side sheet polarizer
63 Upper-side sheet polarizer
64 Wide view A
65 Glare-poof reflection control film
66 Liquid crystal cell
67 Backlight

### DETAILED DESCRIPTION OF THE INVENTION

Embodiments of the invention wherein a rubbing-utilized orientation method is adopted are illustrated first.

The polarization ability of the present sheet polarizers is attributed to orientation of iodine or dichroic dye molecules in their polymer layers. These iodine or dichroic dye molecules become oriented along polymer molecules. The orientation of polymer molecules is effected by a rubbing operation, more specifically subjecting a long film such as a PVA film to a continuous rubbing operation, and not a stretching operation.

Further, the continuous rubbing operation is performed at an oblique angle to the direction in which the film is made to travel. As a result, a sheet polarizer having a transmission axis neither parallel nor perpendicular to the longitudinal direction can be produced.

The transparent substrate for use in the present invention may be made of any material as far as it is transparent, but the materials having transmittance of at least 80% are suitable for the substrate for use in the present invention. Examples of such materials include commercially available olefin polymer films, such as ZEONEX® (produced by Nippon Zeon Co., Ltd.) and ARTON (produced by JSR Co., Ltd.), and commercially available cellulose acylate films, such as FUJITAC® (produced by Fuji Photo Film Co., Ltd.). In addition, polycarbonate, polyallylate, polysulfone and polyether sulfone may also be used as materials for the substrate for use in the present invention. Of those materials, cellulose acylate films are preferred over the others.

With respect to physical properties of substrate materials usable in the invention, suitable value ranges thereof depend on what the substrate is used for. Typical suitable value ranges in the case of using a substrate for general transmission LCD are recited below. The suitable thickness of the substrate is from 5 to 500 μm, preferably from 20 to 200 μm, particularly preferably from 20 to 100 μm, from the viewpoints of easiness in handling and durability. The suitable retardation value at 632.8 nm is in the range of 0 to 150 nm, preferably 0 to 20 nm, particularly preferably 0 to 5 nm. From the viewpoint of avoiding a shift from linear polarization to elliptic polarization, it is advantageous to adjust the slow axis of the substrate so as to be substantially parallel or orthogonal to the absorption axis of a polarization film. However, the same does not go for the case where a polarizing properties-changing function, e.g., a function as a phase retarder, is given to the substrate, but the slow axis of the substrate can form an arbitrary angle with the absorption axis of the sheet polarizer.

Further, it is advantageous that the substrate for use in the present invention has visible light transmittance of at least 60%, particularly at least 90%. The dimensional reduction of the substrate for use in the present invention by thermal treatment at 90° C. for 120 hours is appropriately in the range of 0.3 to 0.01%, particularly 0.15 to 0.01%, and the tensile strength thereof is appropriately in the range of 50 to 1,000 MPa, particularly 100 to 300 MPa, determined by the tensile test for films. In addition, the suitable moisture permeability of the substrate for use in the present invention is from 100 to 800 g/m²·day, particularly 300 to 600 g/m²·day.

It is needless to say that materials whose physical properties are out of the foregoing ranges are also applicable to the substrate for use in the present invention.

Cellulose acylates preferred as materials for the substrate for use in the present invention are described below in detail. With respect to the degree of substitution for hydroxyl groups of cellulose, cellulose acylates satisfying all of the relations (I) to (IV) defined below are used to advantage:
2.6≦A+B≦3.0 (I)
2.0≦A≦3.0 (II)
0≦B≦0.8 (III)
1.9<A−B (IV)

In these relations, A and B represent degrees of substitution of acyl groups for hydroxyl groups of cellulose, and more specifically A is the degree of acetyl substitution and B is the degree of 3-5 C acyl substitution. In view of the presence of 3 hydroxyl groups in each glucose unit of cellulose, each of the figures in (I) and (II) designates how many hydroxyl groups among 3.0 hydroxyl groups are substituted in each glucose unit. Accordingly, the maximum degree of substitution is 3.0. In general, cellulose triacetate has A in the range of 2.6 to 3.0 (This indicates that the maximum number of hydroxyl groups remaining unsubstituted per glucose unit is 0.4). When B is zero, the cellulose triacylate is referred to as cellulose triacetate. Cellulose triacylates suitable for the substrate of a sheet polarizer according to the invention include cellulose triacetate corresponding to the case where all the acyl groups are acetyl groups, and cellulose triacylates wherein the degree of acetyl substitution is at least 2.0, the degree of 3-5 C acyl substitution is at most 0.8 and the degree of no substitution for hydroxyl groups is at most 0.4. With respect to the 3-5 C acyl substitution, the cellulose triacylate can have especially favorable physical properties when the degree of such substitution is not greater than 0.3. Additionally, the degrees of substitution of those groups can be estimated by measuring the proportions of acetic acid and 3-5 C fatty acids bonded to hydroxyl groups of cellulose. These measurements can be made according to the methods defined in ASTM D-817-91.

As to the acyl groups other than acetyl group, 3-5 C acyl groups are specifically propionyl group (C₂H₅CO—), n- and iso-butyryl groups (C₃H₇CO—) and n-, iso-, sec- and tert-valeryl groups (C₄H₉CO—). Of these acyl groups, the groups having normal alkyl moieties are preferred over the others because the cellulose acylated thereby can have high solubility and can be formed into film having high mechanical strength. In particular, n-propionyl group is advantageous. When the degree of acetyl substitution is low, the film formed is inferior in mechanical strength and moisture- and heat-resisting properties. Although an increase in the degree of 3-5 C acyl substitution results in improved solubility of cellulose acylate in organic solvents, satisfactory physical properties can be obtained as far as the degree of each substitution is within the ranges mentioned above.

The suitable polymerization degree (viscosity average) of cellulose acylate is from 200 to 700, particularly preferably from 250 to 550. The viscosity average polymerization degree can be determined by the use of the intrinsic viscosity [η] of cellulose acylate measured with an Ostwald's viscometer and the following equation:
DP=[η]//Km
wherein DP is a viscosity average polymerization degree, and Km is a constant having the value of 6×10⁻⁴.

Examples of the cellulose used as a starting material of cellulose acylate include cotton linters, wood pulp, etc., and any cellulose acylate made from any cellulose as the starting material can be used. And raw materials may be used alone or as a mixture.

The cellulose acylate film is generally made using a solvent cast method. In the solvent cast method, a concentrated solution (hereinafter referred to as “dope”) prepared by dissolving cellulose acylate and various additives in a solvent is cast over an. endless support, such as a drum or a band, and then the solvent is removed therefrom by vaporization, thereby forming a film. The solid-component concentration of the dope is preferably adjusted to the range of 10 to 40 weight %. The drum or band surface is preferably subjected in advance to a mirror-smooth finish. The casting and drying techniques usable in the solvent cast method are disclosed in U.S. Pat. Nos. 2,336,310, 2,367,603, 2,492,078, 2,492,977, 2,492,978, 2,607,704, 2,739,069 and 2,739,070, British Patents 640,731 and 736,892, JP-B-45-4554, JP-B-49-5614 (the term “JP-B” as used herein means an “examined Japanese publication”), JP-A-60-176834, JP-A-60-203430 and JP-A-62-115035.

The arts of casting dopes in two or more layers can be used to advantage, too. In the case of casting two or more dopes, the solutions each containing dopes may be formed into a film while they are cast successively from their respective casting dies disposed at intervals in the machine direction of the support and laminated one on top of the other. Therein, the methods disclosed in JP-A-61-158414, JP-A-1-122419 and JP-A-11-198285 can be adopted. The film formation by casting cellulose acylate solutions from two casting dies can be carried out using the methods as disclosed in JP-B-60-27562, JP-A-61-94724, JP-A-61-947245, JP-A-61-104813, JP-A-61-158413 and JP-A-6-134933. In addition, the casting method disclosed in JP-A-56-162617 is favorably adopted, wherein the flow of a high-viscosity dope is enveloped in a low-viscosity dope and both dopes are extruded simultaneously.

Examples of an organic solvent used for dissolving cellulose acylate include hydrocarbons (such as benzene and toluene), halogenated hydrocarbons (such as methylene chloride and chlorobenzene), alcohols (such as methanol, ethanol and diethylene glycol), ketones (such as acetone), esters (such as ethyl acetate and propyl acetate) and ethers (such as tetrahydrofuran and methyl cellosolve). Of these solvents, halogenated hydrocarbons containing 1 to 7 carbon atoms are preferred over the others. In particular, methylene chloride is used to advantage. Further, it is effective to mix methylene chloride with one or more of an alcohol containing 1 to 5 carbon atoms from the viewpoint of ensuring desirable physical properties, e.g., high solubility of cellulose acylate, easiness in peeling the film from a support and satisfactory mechanical strength and optical characteristics of the film. The suitable proportion of such an alcohol is from 2 to 25 weight %, preferably from 5 to 20 weight %, to the total solvent. Examples of such an alcohol include methanol, ethanol, n-propanol, isopropanol and n-butanol. Of these alcohols, methanol, ethanol, n-butanol and mixtures thereof are preferably used.

In addition to cellulose acylate, any of ingredients which become solids after drying, including a plasticizer, an ultraviolet absorbent, inorganic fine grains, a thermal stabilizer such as salts of alkaline earth metals (e.g., calcium, magnesium), an antistatic agent, a flame retarder, a slip additive, an unctuous agent, an additive for promotion of release from a support and a cellulose acylate hydrolysis inhibitor, can be mixed in a dope.

Suitable examples of a plasticizer mixed in a dope include phosphoric acid esters and carboxylic acid esters. Examples of a phosphoric acid ester include triphenyl phosphate (TPP), tricresyl phosphate (TCP), cresyldiphenyl phosphate, octyldiphenyl phosphate, diphenylbiphenyl phosphate, trioctyl phosphate and tributyl phosphate. Representatives of such carboxylic acid esters are phthalic acid esters and citric acid esters. Examples of a phthalic acid ester include dimethyl phthalate (DMP), diethyl phthalate (DEP), dibutyl phthalate (DBP), dioctyl phthalate (DOP), diphenyl phthalate (DPP) and diethylhexyl phthalate (DEHP). Examples of a citric acid ester include triethyl O-acetylcitrate (OACTE), tributyl O-acetylcitrate (OACTB), triethyl citrate and tributyl citrate. Examples of other carboxylic acid esters include butyl oleate, methyl O-acetylricinolate, dibutyl cebacate and trimellitic acid esters such as trimethyl trimmelitate. Examples of a glycolic acid ester include triacetin, tributyrin, butylphthalylbutyl glycolate, ethylphthalylethyl glycolate and methylphthalylethyl glycolate.

Of the plasticizers recited, triphenyl phosphate, biphenyldiphenyl phosphate, tricresyl phosphate, cresyldiphenyl phosphate, tributyl phosphate, dimethyl phthalate, diethyl phthalate, dibutyl phthalate, dioctyl phthalate, diethylhexyl phthalate, triacetin, ethylphthalylethyl glycolate and trimethyl trimellitate are preferred over the others. In particular triphenyl phosphate, biphenyldiphenyl phosphate, diethyl phthalate, ethylphthalylethyl glycolate and trixnethyl trimellitate are used to advantage. These plasticizers may be used alone or as a mixture of two or more thereof. The proportion of total plasticizers added is preferably from 5 to 30 weight %, particularly preferably from 8 to 16 weight %, to the cellulose acylate. Those compounds may be added together with a cellulose acylate and a solvent at the beginning of preparing a solution, or they may be added during or after preparing a cellulose acrylate solution.

The ultraviolet absorbent can be selected from a wide variety of known ones depending on the desired purpose. Specifically, absorbents of salicylate, benzophenone, benzotriazole, benzoate, cyanoacrylate and nickel complex salt types can be used. Of these absorbents, those of benzophenone, benzotriazole and salicylate types are preferred over the others. Examples of an ultraviolet absorbent of benzophenone type include 2,4-dihydroxybenzophenone, 2-hydroxy-4-acetoxybenzophenone, 2-hydroxy-4-methoxybenzophenone, 2,2′-dihydroxy-4-methoxy-benzophenone, 2,2′-dihydroxy-4,4′-methoxybenzophenone, 2-hydroxy-4-n-octoxybenzophenone, 2-hydroxy-4-dodecyloxybenzophenone and 2-hydroxy-4-(2-hydroxy-3-methacryloxy)-propoxybenzophenone. Examples of an ultraviolet absorbent of benzotriazole type include 2-(2′-hydroxy-3′-tert-butyl-5′-methylphenyl)-5-chlorobenzotriazole, 2-(2′-hydroxy-5′-tert-butylphenyl) benzotriazole, 2-(2′-hydroxy-3′,5′-di-tert-amylphenyl)benzotriazole, 2-(2′-hydroxy-3′,5′-di-tert-butylphenyl)-5-chlorobenzotriazole and 2-(2′-hydroxy-5′-tert-octylphenyl)benzotriazole. Examples of an ultraviolet absorbent of salicylate type include phenyl salicylate, p-octylphenyl salicylate and p-tert-butylphenyl salicylate. Of the ultraviolet absorbents recited above, 2-hydroxy-4-methoxybenxophenone, 2,2′-dihydroxy-4,4′-methoxybenzophenone, 2-(2′-hydroxy-3′-tert-butyl-5′-methylphenyl)-5-chlorobenzotriazole, 2-(2′-hydroxy-5′-tert-butylphenyl)benzotriazole, 2-(2′-hydroxy-3′,5′-di-tert-amylphenyl)benzotriazole and 2-(2′-hydroxy-3′,5′-ditert-butylphenyl)-5-chlorobenzotriazole are preferred in particular.

The combined use of two or more of absorbents differing in absorption wavelength is especially advantageous because high shielding effect can be achieved over a wide wavelength range. The suitable proportion of absorbents added is from 0.01 to 5 weight %, preferably 0.1 to 3 weight %, to the cellulose acylate. Those ultraviolet absorbents may be added together with cellulose acylate in the stage of dissolving the cellulose acylate, or they may be added to a dope in which the cellulose acylate is dissolved. The especially desirable addition mode consists in that a solution of ultraviolet absorbents is added to a dope by means of a static mixer just before casting.

Inorganic fine grains added to cellulose acylate can be selected arbitrarily from conventional inorganic fine grains, including silica, kaoline, talc, diatomaceous earth, quartz, calcium carbonate, barium sulfate, titanium dioxide and alumina, depending on the desired purpose. Before adding these fine grains to a dope, they are preferably dispersed into a binder solution by the use of an arbitrary means, such as a high-speed mixer, a ball mill, an attriter or an ultrasonic disperser. As such a binder, cellulose acylate is preferred. It is also favorable to disperse them together with other additives, e.g., ultraviolet absorbents. Although any solvents can be used for dispersion, it is advantageous to use a solvent having a composition close to that of the dope solvent. The suitable number average size of grains dispersed is from 0.01 to 100 μm, particularly preferably from 0.1 to 10 μm. The dispersion of inorganic fine grains may be added at the time when cellulose acylate is dissolved, or it can be added to the dope in any stage. However, similarly to the ultraviolet absorbents, it is advantageous to adopt a mode that the dispersion is added using a static mixer just before casting.

As examples of an additive useful for promoting the release from a support, mention may be made of surfactants, which have no particular restrictions on their types. Any of anionic surfactants, including those of phosphoric acid, sulfonic acid and carboxylic acid types, nonionic surfactants and cationic surfactants can be used as such an additive. Those surfactants are described, e.g., in JP-A-61-243837.

In using as the substrate according to the present invention the cellulose acylate film formed in the manner as mentioned above, it is advantageous to previously render the film surface hydrophilic by the use of such a means as saponification, corona, flame or glow discharge treatment from the viewpoint of enhancing the adhesion to a PVA resin. In another way, a hydrophilic resin dispersed in a solvent having an affinity for cellulose acylate may be coated in a thin layer on the cellulose acylate film. Of these means, the saponification treatment is preferred in particular because it does not damage the planarity and physical properties of the film. The saponification treatment is carried out, e.g., by immersion of the film in an aqueous solution of alkali, such as sodium hydroxide. After the treatment, it is desirable to neutralize the film with an acid solution having low concentration for removing the excess alkali, and then wash thoroughly.

The sheet polarizer of the present invention can have on the substrate surface any of the functional layers as disclosed in JP-A-4-229828, JP-A-6-75115 and JP-A-8-50206, including an optically anisotropic layer for wide viewing of LCD, a glare-proof layer and a reflection control layer for improving the visibility of the display, a layer which can raise the brightness of LCD by having a PS wave separative function based on anisotropic scattering and anisotropic optical interference (e.g., a polymer-dispersed liquid crystal layer, a cholesteric liquid crystal layer), a hard coating layer for heightening the scratch resistance of the sheet polarizer, a gas barrier layer for controlling the diffusion of moisture and oxygen, an adhesive layer for increasing adhesion to a polarization film, an adhesive or a tackiness agent, and a slippability imparting layer.

Those functional layers may be arranged on the polarization film side or the side opposite to the polarization film. The location thereof can be chosen properly depending on the desired purpose.

On one side or both sides of the polarization film for use in the present invention, various functional films can be laminated directly as protective film. Examples of such functional films include a phase difference film such as a λ/4 plate or a λ/2 plate, a light diffusion film, a plastic cell provided with a conductive layer on the side opposite to the polarization film, a brightness increasing film having a anisotropic scatter and anisotropic optical interference function, a reflector plate and a semitransmissible reflector plate.

Only one of the desirable substrates as recited above or a laminate of two or more thereof can be used as a protective film of the polarization film. The same protective film may be stuck on both sides of the polarization film, or the protective films stuck on both sides may be different from each other in functions and physical properties. Further, it is possible that the foregoing protective film is stuck on one side alone and no protective film on the other side. In this case, a tackiness agent layer instead of the protective film is provided for the purpose of directly providing the liquid crystal cell, and it is favorable to provide a releasable separator film on the outside of the tackiness agent.

In accordance with one of the present embodiments, the orientation method utilizing a rubbing treatment instead of a stretching treatment is adopted, in the case of using the transparent substrate on the liquid crystal cell side, it is desirable to control birefringence of the substrate. When the principal refractive indices in the plane parallel to the substrate surface are symbolized as nx and ny, the principal refractive index in the thickness direction of the substrate as nz and the substrate thickness as d, it is desirable that the principal refractive indices along three axes satisfy the relation nz<ny<nx (biaxiality) and the retardation defined by an expression {(nx+ny)/2−nz}×d be from 20 nm to 400 nm (preferably from 30 nm to 200 nm). The suitable front retardation defined as |nx−ny×d is at most 100 nm, preferably at most 60 nm. When the transparent substrate and the liquid crystal cell are arranged on opposite sides of the polymer layer, however, the transparent substrate has no restriction on its birefringence.

Further, it is advantageous to provide a subbing layer on the transparent substrate for the purpose of increasing the adhesion strength between the transparent substrate and the polymer layer. In general, gelatin is used for the subbing layer.

The polymer layer for use in the present invention has no particular restriction as to polymers used therein. Specifically, not only self-crosslinking polymers but also polymers capable of being cross-linked with a cross-linking agent can be used. The polymer layer can be formed by causing a reaction between functional group-containing polymers by exposure to light, heat or change in pH, or by introducing functional groups into polymers and causing a reaction between the resulting polymers by exposure to light, heat or change in pH, or by making polymers be cross-linked with a cross-linking agent as a highly reactive compound to introduce bonding groups between the polymers.

Such cross-links can be generally formed by coating on a transparent substrate a coating solution containing the polymer as mentioned above or the polymer/cross-linking agent mixture, and then exposing the coating to, e.g., heat. Since it is enough for the polymer layer to secure durability in the stage of final product, the cross-linking treatment may be carried out in any of the stages from the coating of the polymer solution on the transparent substrate to the completion of a sheet polarizer. In the case of coating on a transparent substrate a coating solution containing a polymer and a cross-linking agent capable of cross-linking the polymer, for instance, the coating is dried by heating and then subjected to rubbing treatment for orientation of polymer molecules, and further iodine or a dichroic dye is adsorbed to the polymer molecules in an oriented state, thereby forming a sheet polarizer.

The polymers used in the invention can be polymers capable of cross-linking by themselves or polymers capable of undergoing cross-linking reaction in the presence of a cross-linking agent. Of course, the polymers having both of the foregoing capabilities may be used. Examples of polymers usable in the invention include polymethyl methacrylate, acrylic acid/methacrylic acid copolymer, styrene/maleinimide copolymer, PVA, modified PVA, poly (N-methylolacrylamide), styrene/vinyltoluene copolymer, chlorosulfonated polyethylene, nitrocellulose, polyvinyl chloride, chlorinated polyolefin, polyester, polyimide, vinyl acetate/vinyl chloride copolymer, ethylene/vinyl acetate copolymer, carboxymethyl cellulose, gelatin, polyethylene, polypropylene, polycarbonate, and compounds such as a silane coupling agent. Of these polymers, water-soluble polymers such as poly (N-methylolacrylamide), carboxymethyl cellulose, gelatin, PVA and modified PVA are preferred over the others. Further, gelatin, PVA and modified PVA, especially PVA and modified PVA, are used to advantage.

PVA usable in the invention has a saponification degree in the range of, e.g., 70 to 100%, generally 80 to 100%, preferably 95 to 100%. The suitable polymerization degree thereof is from 100 to 5,000.

Examples of modified PVA usable in the invention include PVA modified by copolymerization (into which COONa, Si(OH)₃, N(CH₃)₃, Cl, C₉H₁₉C00, SO₃Na or/and C₁₂H₂₅ groups are introduced for modification), PVA modified by chain transfer (into which COONa, SH or/and C₁₂H₂₅S groups are introduced for modification) and PVA modified by block polymerization (into which COOH, CONH, COOR (R: alkyl) or/and C₆H₅ groups are introduced for modification). The suitable polymerization degree of such modified PVA is from 100 to 3,000. Of these polymers, unmodified and modified PVA having their saponification degrees in the range of 80 to 100% are preferable.

In the polymer layer for use in the present invention, PVA or modified PVA of the kinds recited above may be used alone or as a mixture of two or more thereof.

The modified PVA used to particular advantage includes the compounds disclosed in JP-A-8-338913, JP-A-9-152509 and JP-A-9-316127.

Cross-linking agents usable in the invention have no particular restrictions. The addition amount thereof shows a tendency that the greater it is, the more the polymer layer improves in resistance to moisture and heat. However, the orientation capability of the polymer layer by rubbing deteriorates when the proportion of the cross-linking agent to the polymer is increased beyond 50% by weight. Therefore, the cross-linking agent is preferably used in a proportion of 0.1 to 20% by weight, particularly preferably 0.5 to 15% by weight, to the polymer. Although the oriented film according to the invention contains a certain proportion of cross-linking agent remaining unreacted even after the cross-linking reaction comes to the end, it is desirable to decrease the proportion of cross-linking agent remaining in the polymer layer to at most 1.0% by weight, preferably at most 0.5% by weight. When the unreacted cross-linking agent is contained in a proportion increased beyond 1.0% by weight, the polymer layer cannot have sufficient durability. More specifically, such a polymer layer tends to cause a lowering of efficiency of polarization upon long-term use in a liquid crystal display or long-term storage under the atmosphere of high temperature and high humidity.

Examples of a cross-linking agent usable in the invention include the compounds disclosed in U.S. Reissue Pat. No. 23,297. Of those cross-linking agents, boric acids (e.g., boric acid, borax) are used advantage.

The polymer layer for use in the present invention can be basically formed by coating a solution containing the polymer and the cross-linking agent as recited above on a transparent substrate, drying by heating (to cause cross-linking reaction) and rubbing the coating surface. The cross-linking reaction, as mentioned above, may be carried out in an arbitrary stage after coating the solution on the transparent substrate. In the case of using a water-soluble polymer, such as PVA, as the oriented film forming material, a mixture of water with an organic solvent having a defoaming action, such as methanol, is preferably employed as the solvent of the coating solution. The suitable ratio of water to methanol is generally from 0:100 to 99:1, preferably from 0:100 to 91:9, by weight. By the use of such a mixed solvent, the generation of foams can be prevented to ensure markedly decreased defects in the sheet polarizer formed. Examples of a coating method which can be adopted include a spin coating method, a dip coating method, a curtain coating method, an extrusion coating method, a bar coating method and an extrusion-type (E-type) coating method. Of these methods, the E-type coating method is preferred over the others. The suitable thickness of the polymer layer is from 0.1 to 100 μm. The drying by heating can be performed at a temperature of 20° C. to 1 1° C. In order to form cross-links to a satisfactory extent, the drying temperature is preferably from 60° C. to 100° C., particularly preferably from 80° C. to 100° C. The drying time is generally from 1 minute to 36 hours, preferably from 5 to 30 minutes. Further, it is favorable to adjust the pH to an optimum value for the cross-linking agent used. In the case of using glutaraldehyde as a cross-linking agent, the suitable pH is from 4.5 to 5.5, especially 5.

Examples of dichroic molecules include dye compounds, such as azo dyes, stilbene dyes, pyrazolone dyes, triphenylmethane dyes, quinoline dyes, oxazine dyes, thiazine dyes and anthraquinone dyes. Of these dyes, water-soluble dyes are preferred, but there are cases to which this preference is not applicable. However that may be, it is desirable that hydrophilic substituent groups, such as sulfonic acid, amino and hydroxyl groups, be introduced into those dyes. More specifically, C.I. DIRECT YELLOW® 12, C.I. DIRECT ORANGE® 39, C.I. DIRECT ORANGE® 72, C.I. DIRECT RED® 39, C.I. DIRECT RED® 79, C.I. DIRECT RED® 81, C.I. DIRECT RED® 83, C.I. DIRECT RED® 89, C.I. DIRECT VIOLET® 48, C.I. DIRECT BLUE® 67, C.I. DIRECT BLUE® 90, C.I. DIRECT GREEN® 59, C.I. ACID RED® 37, and the dyes disclosed in JP-A-1-161202, JP-A-1-172906, JP-A-1-172907, JP-A-1-183602, JP-A-1-248105, JP-A-1-265205 and JP-A-7-261024 are given as suitable examples. These dichroic dyes are used as free acids, alkali metal salts, ammonium salts or amine salts. By mixing variously two or more of those dichroic dyes, polarizers differing in hue can be produced. Compounds (dyes) or mixtures of different dichroic molecules can ensure excellent single-plate transmittance and efficiency of polarization as far as they can provide black color when the polarizing elements or the sheet polarizers comprising them are placed so that their polarizing axes intersect at right angles.

A coating solution for applying iodine or a dichroic dye to the polymer layer can be prepared by dissolving idone or the dichroic dye in an appropriate solvent. Examples of such a solvent include polar solvents such as N,N-dimethylformamide (DMF), dimethyl sulfoxide (DMSO) and pyridine, nonpolar solvents such as benzene and hexane, alkyl halides such as chloroform and dichloromethane, esters such as methyl acetate and butyl acetate, ketones such as acetone and methyl ethyl ketone, and ethers such as tetrahydrofuran and 1,2-dimethoxyethane. The preferred solvents are those which enable the adsorption of iodine or dichroic dye molecules in an oriented state without causing relaxation in orientation of the polymer layer, and can be chosen properly depending on the kind of a polymer used. Those solvents may be used alone or as a mixture of two or more thereof.

The appropriate coverage of iodine or dichroic dye is from 0.01 to 10 g/m², preferably from 0.05 to 1 g/m².

Examples of a method for coating the solution as mentioned above include a curtain coating, extrusion coating, roll coating, dip coating, spin coating, print coating, spray coating and slide coating methods. In the case of a mixture of discotic compounds alone, an evaporation method can also be adopted in the invention. Further, continuous coating is advantageous to the invention. Therefore, curtain coating, extrusion coating and roll coating and slide coating methods are preferred over the others.

On the polymer layer to which iodine or dichroic dye molecules are adsorbed in an oriented state, a protective layer may be provided. Such a protective layer may be made from any of polymers as far as they have high transparency as in the case of the transparent substrate as mentioned above. When the film of such a polymer is used as a protective film, it is favorable to stick the polymer film on the polymer layer with a pressure adhesive layer.

It is also possible to form a protective film by coating a polymerizable monomer on the polymer layer and polymerizing it there. This case is preferable because it can provide a thin protective film, compared with the case of sticking a film.

Suitable examples of a polymerizable monomer include compounds containing vinyl, vinyloxy, acryloyl and methacryloyl groups respectively.

For the rubbing treatment can be adopted the treatment methods widely used for orientating liquid crystals of LCD. More specifically, the method of rubbing the surface of an orientation film in a fixed direction by means of paper, gauze, felt, rubber, or nylon or polyester fiber can be employed for orientation. In general the orientation can be carried out by rubbing several times the polymer surface with cloth into which fibers having the same length and the same diameter are transplanted evenly. Preferably, the rubbing treatment method adopted in the invention is characterized by being furnished with a rubbing roll wherein the circularity, cylindricality and deflection of the roll itself are all 30 μm or below. The suitable wrap angle of a film with a rubbing roll is from 0.1 degree to 90 degrees. However, as disclosed in JP-A-8-160430, there is a case that the steady rubbing treatment is effected by winding a film around the roll at an angle of 360 degrees or more.

In the case of rubbing a long film, it is desirable that the film be conveyed at a speed of 1 to 100 meters a minute as uniform tension is imposed thereon. Further, in order to make it possible to set up an arbitrary rubbing angle, it is desirable for the rubbing roll to be in a state that it can swing in the plane level with the machine direction. And it is appropriate to choose the rubbing angle from the range of 0 to 60 degrees. In particular, it is advantageous to adjust the rubbing angle to 45 degrees. In the case of using the rubbed long film for LCD's, it is effective to set the rubbing angle from 40 to 50 degrees.

In the next place, embodiments of the invention wherein oblique stretching is utilized for the orientation are illustrated.

When the obliquely stretched polarization layer is stuck on a transparent substrate by the use of rolls, as shown in FIG. 3, the absorption axis 14 of the polarization layer deviates from the machine direction (long direction) of the transparent substrate 11 (x axis). As a result, the linear polarization by birefringence of the transparent substrate becomes elliptic polarization. Therefore, it is especially desirable that the refraction indices in the x, y and z directions, nx, ny and nz, satisfy the relations defined hereinbefore. As examples of a transparent substrate having such refraction indices, mention may be made of commercially available films, such as ZEONEX® and ZEONOA® (trade names, products of Nippon Zeon Co., Ltd.), ARTON (trade name, a product of JSR Co., Ltd.) and FUJITAC® (trade name, a triacetyl cellulose product of Fuji Photo Film Co., Ltd.), and non-birefringent optical resin materials disclosed in JP-A-8-1 10402 and JP-A-1 1-293116.

For the purpose of improving the adhesion of a transparent substrate to the polarization layer, the substrate may be subjected to a surface treatment, such as a chemical treatment (e.g., saponification), a mechanical treatment, a corona treatment or a glow treatment, and provided with a hydrophilic subbing layer (e.g., a gelatin layer) having an affinity for PVA soluble in water.

PVA is used for the polarization layer. Although PVA is generally a saponification product of polyvinyl acetate, it may contain monomer units copolymerizable with vinyl acetate, such as unsaturated carboxylic acids, unsaturated sulfonic acids, olefins or/and vinyl ethers. Further, modified PVA wherein acetoacetyl groups, sulfonic acid groups, carboxylic acid groups, or oxyalkylene groups are contained can also be used.

The saponification degree of PVA is not particularly limited, but it is preferably from 80 to 100 mole %, particularly preferably from 90 to 100 mole %, from the viewpoint of solubility. Also, the polymerization degree of PVA has no particular limitation, but it is preferably from 1,000 to 10,000, particularly preferably from 1,500 to 5,000.

The polarization layer for use in the present invention is produced as follows: A solution of PVA in water or an organic solvent is cast-coated into a film, and the film obtained is stretched and then dyed with iodine or a dichroic dye, or it is dyed first and then stretched. As a solvent other than water, alcohols (e.g., methanol, ethanol, propanol, butanol), polyhydric alcohols (e.g., glycerol, ethylene glycol, propylene glycol, diethylene glycol, triethylene glycol, tetraethylene glycol, trimethylol propane), amines (e.g., ethylenediamine, diethylenetriamine), dimethyl sulfoxide and N-methylpyrrolidone can be used alone or as a mixture of two or more thereof.

The stretching direction of PVA film forms an angle of 10 to 80 degrees with the machine direction of the film upon cast coating. This inclination in the stretching operation is adjusted to an angle that the transmission axis of two sheet polarizers stuck on both side of a liquid crystal cell constituting LCD makes with the longitudinal or transverse direction of the liquid crystal cell.

Such an angle is generally 45 degrees, but it is not always 45 degrees in some of the latest transmission, reflection or semi-transmission type LCD modes. Therefore, it is desirable that the PVA film-stretching direction be adjustable in order to conform to the design of LCD.

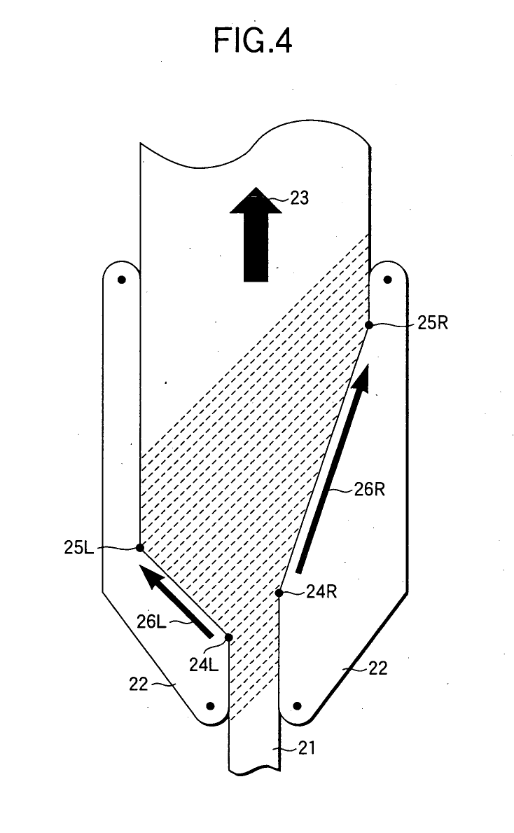

An example of the stretching of film at an oblique angle of 45 degrees is shown in FIG. 4. The numeral 21 denotes a PVA film, the numeral 22 a tenter, and the numeral 23 the direction in which the film travels. The width change of the film in the stretching direction is shown by dotted lines. The PVA film chucked at a certain time in the position 24L and 24R shown in the figure is moved to the position 25L at a speed of 26L on the left side and, on the right side, it is moved to the position 25R at a speed of 26R, thereby achieving the oblique stretching.

The suitable stretch magnification is from 2.5 to 30.0, preferably from 3.0 to 10.0. The stretching may be dry stretching carried out in the air, or wet stretching carried out in a state of water immersion. In the case of dry stretching the stretch magnification is from about 2.5 to about 5.0; while it is from about 3.0 to about 10.0 in the case of wet stretching. The oblique stretching operation may be carried out in several installments. By doing so, more uniform stretching can be achieved even in the cases of stretching of high magnifications. In addition, slight stretching in the longitudinal or transverse direction (to such an extent that the shrinkage in the width direction can be prevented) may be carried out before the oblique stretching.

As the oblique stretching can be achieved by, e.g., carrying out tenter stretching for the biaxial stretching as in general film formation under the conditions differing between the left side and the right side as mentioned above, specifically stretching the film at speeds differing between the left side and the right side, the PVA film before stretch operation is required to differ in thickness between the left side and the right side. In the case of film formation by cast coating, therefore, the method of making a difference between flow rates of a PVA solution on the left side and the right side by the use of, e.g., a die taper in shape can be adopted.

In such a process, the PVA film for use in the present invention which is stretched at an angle of 10 to 80 degrees with the machine direction can be produced.

The dyeing process is performed by gas- or liquid-phase adsorption. In the case of dyeing in liquid phase by the use of iodine, PVA film is immersed in a water solution of iodine-potassium iodide mixture. In the water solution, the suitable iodine concentration is from 0.1 to 2.0 g/l, the suitable potassium iodide concentration is from 10 to 50 g/l, and the suitable ratio of iodine to potassium iodide is from 20 to 100 by weight. The suitable dyeing time is from 30 to 5,000 seconds, and the suitable solution temperature is from 5 to 50° C. As to the dyeing method, not only immersion but also any of other means, including coating and spraying of iodine or a dye solution, may be employed.

Examples of dichroic dyes usable herein include azo dyes, stilbene dyes, quinone dyes, anthraquinone dyes, methine dyes, azomethine dyes, cyanine dyes, merocyanine dyes, quinophthalone dyes and tetrazine dyes. Of these dyes, the dichroic dyes of azo type and anthraquinone type are preferred in particular.

The PVA film dyed in the foregoing process is subjected to cross-linking treatment with a boron compound or an aldehyde. In particular, the cross-linking treatment with a boron compound is preferred. The boron compound used in this treatment is, e.g., boric acid or borax. More specifically, the boron compound is dissolved in water or a mixture of water and an organic solvent so as to have a concentration of 0.5 to 2.0 mole/l, and coated or sprayed on the dyed PVA film. In the other way, the film may be immersed in such a boron compound solution. Additionally, it is desirable to add a small amount of potassium iodide to the boron compound solution. The suitable treatment temperature is from 40 to 70° C., and the suitable treatment time is from 5 to 20 minutes. During the treatment, the oblique stretching may be carried out once more using the method as mentioned above.

Further, the thus treated PVA film may also be subjected to heat treatment. The suitable water content in the film at the time of this treatment is from 10 to 30%. The suitable treatment temperature is from 40 to 100° C., preferably from 50 to 90° C., and the suitable treatment time is from 0.5 to 15 minutes.

On both sides of the thus produced PVA film functioning as a polarization layer, the transparent substrate as mentioned above is stuck as protective film with an adhesive. The adhesive usable herein has no particular restriction, but preferably includes PVA resins (including modified PVA containing acetoacetyl groups, sulfonic acid groups, carboxyl groups, or oxyalkylene groups) and a water solution of boron compound. Of these adhesives, PVA resins are preferred. The suitable adhesive thickness is from 0.01 to 10 μm, preferably from 0.05 to 5 μm, on a dry basis.

In the sheet polarizer of the present invention, the protective film can be provided, on the side opposite to the polarization layer, with the functional layers as disclosed in JP-A-4-229828, JP-A-6-75115 and JP-A-8-50206, including an optically anisotropic layer for wide viewing of LCD, a glare-proof layer and a reflection control layer for improving the visibility of the display, a layer which can raise the brightness of LCD by having a PS wave separative function based on anisotropic scattering and anisotropic optical interference (e.g., a polymer-dispersed liquid crystal layer, a cholesteric liquid crystal layer).

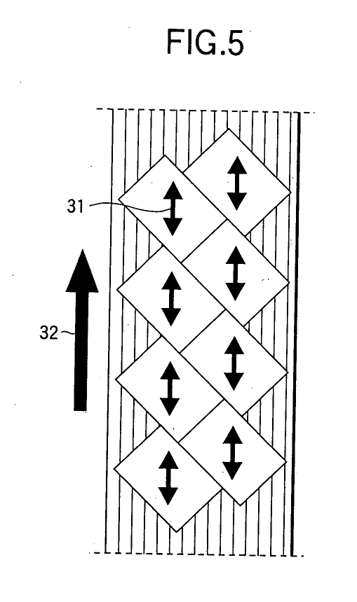

A case of stamping out conventional sheet polarizers is shown in FIG. 5, and a case of stamping out sheet polarizers of the present invention is shown in FIG. 6.

In conventional sheet polarizers, their absorption axis 31 of polarized light, namely their stretching axis, accords with the machine direction 32. In the sheet polarizers of the present invention, on the other hand, their absorption axis 41 of polarized light, namely their stretching axis, makes an angle with the machine direction 42, and this angle 43 accords with an angle that the absorption axis of the sheet polarizer forms with the longitudinal or transverse direction of a liquid crystal cell itself when stuck on the liquid crystal cell as a member of LCD. Accordingly, oblique stamping becomes unnecessary in the stamping process.

Moreover, as seen from FIG. 6, the sheet polarizer of the present invention can be cut in a straight line along 43, so that it can be made into chips by slitting along 43 instead of stamping; as a result, the productivity can be significantly increased.

By combining the sheet polarizer of the present invention with coating type of optical members (e.g., optical compensation film, brightness-up film), it becomes possible to accurately control the transmission axis of the sheet polarizer and the slow axis of each optical member. Therein, the sheet polarizer of the present invention can function more effectively. As examples of coating type of optical members, mention may be made of the optical compensation sheets using liquid crystalline discotic molecules as disclosed in JP-A-6-214116, U.S. Pat. Nos. 5,583,679 and 5,646,703, and German Patent 3911620A1, the optical compensation sheets using liquid crystalline stick molecules as disclosed in JP-A-7-35924, and the brightness-up films as disclosed in JP-A-1 1-149015.

Now, the present invention is illustrated in more detail by reference to the following examples. However, the invention should not be construed as being limited to these examples.

### EXAMPLE 1

On a gelatin layer provided on one side of a film of cellulose acetate having an average acetylation degree of 60.9% (thickness: 80 μm, made by Fuji Photo Film Co., Ltd.), a 10 μm-thick polymer layer having the following composition was provided by coating. As conventional stretched films have their thickness in the neighborhood of 30 μm, the thickness of the polymer layer is about one-third the thickness of conventional ones.

Composition of Polymer Layer:

| | |
|---|---|
| Modified PVA illustrated below | 4 parts by weight |
| Glutaraldehyde | 0.05 part by weight |
| Water | 96 parts by weight |

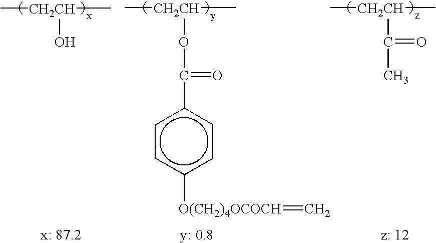

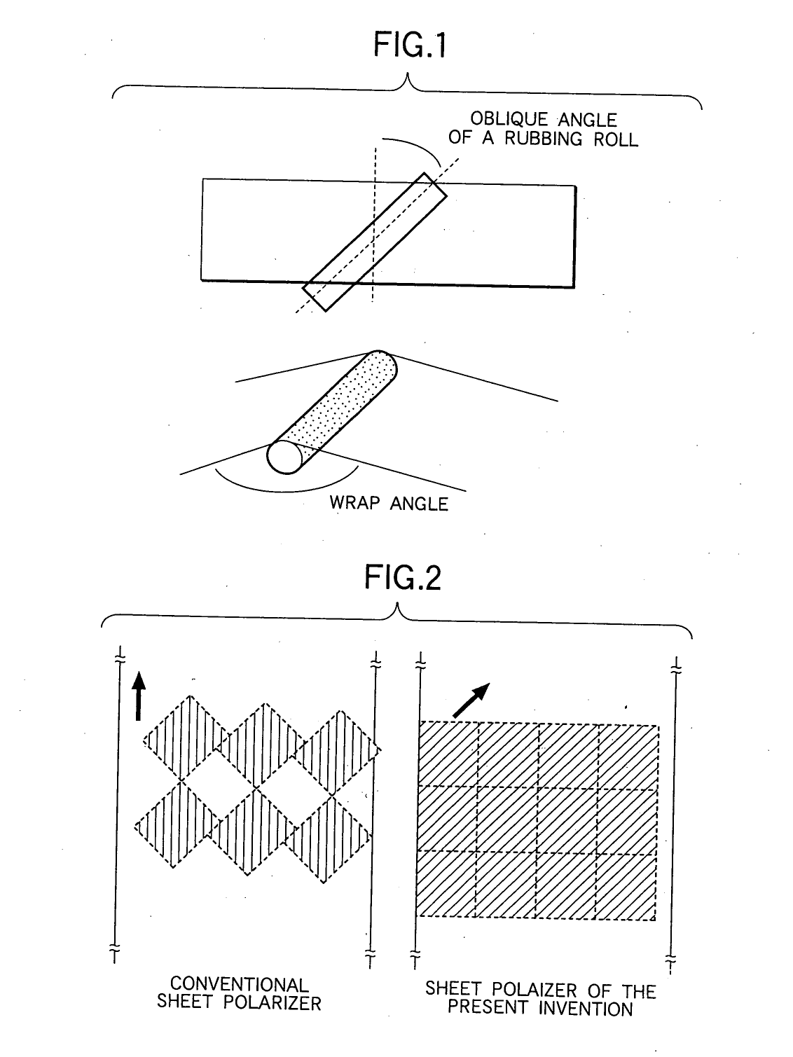

The surface of the polymer layer was subjected to the rubbing treatment according to the method as shown in FIG. 1. More specifically, the rubbing treatment was carried out under conditions that the outside diameter of the rubbing roll used was 300 mm, the film traveling speed was 15 m/min, the circumferential velocity of rubbing roll rotation was 300 m/min the film substrate tension was 2 Kgf per cm of the substrate width, the wrap angle was 30 degrees, and the inclination of the rubbing roll was 45 degrees.

The film substrate provided with the rub-treated polymer layer was allowed to stand for a short while in the 40° C. atmosphere of iodine, and thereby the iodine was adsorbed to the polymer layer and at the same time the cross-linking reaction proceeded in the polymer layer. Thus, a long sheet polarizer (CHB-1) having a transmission axis making an inclination of 45 degrees with the long direction of the film was prepared.

### EXAMPLE 2

On a gelatin layer provided on one side of a film of cellulose acetate having an average acetylation degree of 60.9% (made by Fuji Photo Film Co., Ltd.), a 10 μm-thick polymer layer having the following composition was provided by coating.

Composition of Polymer Layer:

| | | |
|---|---|---|
| Modified PVA (PVA117, trade name, | 4 | parts by weight |
| a product of Kuraray Co., Ltd.) | | |
| Glutaraldehyde | 0.05 | part by weight |
| Water | 96 | parts by weight |

The polymer layer thus formed was subjected to rubbing treatment according to the method as shown in FIG. 1 wherein the same apparatus as in Example 1 was used under the same conditions as in Example 1.

As in the way of Example 1, the film substrate provided with the rub-treated polymer layer was allowed to stand for a short while in the 40° C. atmosphere of iodine, and thereby the iodine was adsorbed to the polymer layer and at the same time the cross-linking reaction proceeded in the polymer layer. Thus, a long sheet polarizer (CHB-2) having a transmission axis making an inclination of 45 degrees with the long direction of the film was prepared.

### EXAMPLE 3

One side of a commercially available ARTON film (a product of JSR Co., Ltd.) was subjected to corona treatment, and then coated with a 5 μm-thick polymer layer having the following composition.

Composition of Polymer Layer:

| | | |
|---|---|---|
| PVA (PVA11O, trade name, a product | 4 | parts by weight |
| of Kuraray Co., Ltd.) | | |
| Black mixture of dyes (C.I. Direct Orange 72, | 1 | part by weight |
| C.I. Blue 67 and C.I. Green 51) | | |
| Nonionic surfactant (Emulgen 108, trade name, | 0.1 | part by weight |
| a product of Kao Corporation) | | |
| Glyoxal | 0.05 | part by weight |
| Methanol | 16.7 | parts by weight |
| Water | 78 | parts by weight |

The polymer layer thus formed was subjected to rubbing treatment using the same apparatus as in Example 1 under the following conditions.

Outside diameter of the rubbing roll: 300 mm

Film traveling speed: 15 m/min

Circumferential velocity of rubbing roll rotation: 400 m/min

Film substrate tension: 2 Kgf per cm of substrate width

Wrap angle: 45 degrees

Inclination of the rubbing roll: 45 degrees

Thus, a long sheet polarizer (CHB-3) having a transmission axis making an inclination of 45 degrees with the long direction of the film was prepared.

Evaluation of Efficiency of Polarization:

Optical characteristics of the sheet polarizers prepared in Examples 1 to 3 at the maximum absorption wavelength were measured with MCPD (made by Shimadzu Corporation). And the measurement results are shown in Table 1.

TABLE 1

| | | | Efficienty of |
|---|---|---|---|
| | Long sheet polarizer | Simple transmittance | Polarization |
| Example 1 | CHB-1 | 23.5% | 49% |
| Example 2 | CHB-2 | 23.0% | 50% |
| Example 3 | CHB-3 | 24.0% | 51% |

Machining into Chips for Liquid Crystal Display:

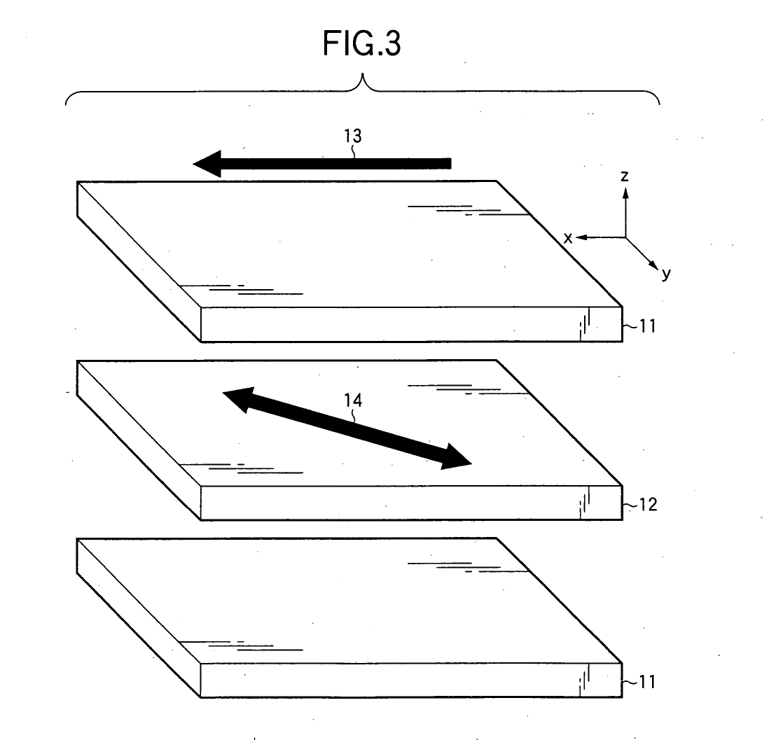

As every conventional sheet polarizer has its transmission axis in the width direction, chips are prepared by cutting the sheet polarizer in the 45-degree direction as shown in FIG. 2. On the other hand, each of the sheet polarizers of the present invention has its transmission axis in the direction making an angle of 45 degrees with the width direction. Therefore, rectangular chips can be cut out efficiently from the sheet polarizer of the present invention in the way shown in FIG. 2 to result in significant reduction of a loss in the chipping, though the number of rectangular chips cut out is small in the conventional case where the cutting in the 450 direction is required.

### EXAMPLE 4

PVA having an average polymerization degree of 4,000 and a saponification degree of 99.8 mole % was dissolved in water to obtain a 4.0% aqueous solution of PVA. This solution was cast over a band by the use of a die taper in shape so as to form a film having a width of 110 mm, a left-side thickness of 120 μm and a right-side thickness of 135 μm on a dry basis, followed by drying.

The film thus formed was peeled apart from the band, stretched in the 45-degree direction in a dry state, immersed in a 30° C. water solution containing 0.5 g/l of iodine and 50 g/l of potassium iodide for 1 minute, and then immersed in a 70° C. water solution containing 100 g/l of boric acid and 60 g/l of potassium iodide for 5 minutes. The thus processed film was further washed for 10 seconds by dipping in a 20° C. water wash tank, and then dried at 80° C. for 5 minutes. Thus, an iodine-doped polarization film having a width of 660 mm and a thickness of 20 μm on both sides was prepared.

### EXAMPLE 5

PVA having an average polymerization degree of 1,700 and a saponification degree of 99.5 mole % was dissolved in water to obtain a 5.0% aqueous solution of PVA. This solution was cast over a band by the use of a die taper in shape so as to form a film having a width of 110 mm, a left-side thickness of 180 μm and a right-side thickness of 195 μm on a dry basis, followed by drying.

The film thus formed was peeled apart from the band, immersed in a 30° C. water solution containing 0.2 g/l of iodine and 60 g/l of potassium iodide for 5 minute, and then immersed in a water solution containing 100 g/l of boric acid and 30 g/l of potassium iodide at 60° C. for 10 minutes while the film was stretched in the 45-degree direction. By this stretching operation, the film came to have a width of 660 mm and a thickness of 30 μm on both sides.

Further, the thus processed film was washed for 10 seconds by dipping in a 20° C. water wash tank, then immersed in a 30° C. water solution containing 0.1 g/l of iodine and 20 g/l of potassium iodide for 15 seconds, followed by 24-hour drying at room temperature. Thus, an iodine-doped polarization film was prepared.

On each side of this polarization film, a 80 μm-thick triacetyl cellulose film (made by Fuji Photo Film Co., Ltd.) was stuck with an PVA adhesive, and dried at 50° C. for 5 minutes to form a sheet polarizer.

As to the optical characteristics of the triacetyl cellolose film used, the maximum of (nx−ny)×d values and the maximum of {(nx+ny)/2−nz}×d values at wavelengths ranging from 380 nm to 780 nm were 10 nm and 40 nm respectively.

### EXAMPLE 6

A sheet polarizer was prepared in the same manner as in Example 5, except that the triacetyl cellulose film used as a protective film was replaced by a 50 μm-thick Zeonoa (trade name, a product of Nippon Zeon Co., Ltd.).

As to the optical characteristics of the Zeonoa film used, the maximum of (nx−ny)×d values and the maximum of {(nx+ny)/2−nz}×d values at wavelengths ranging from 380 nm to 780 nm were 3.3 nm and 8.2 nm respectively.

### COMPARATIVE EXAMPLE 1

A commercially available iodine-doped sheet polarizer (HLC2-5518, width 650 mm, a product of Sanritz Co., Ltd.) was employed as a comparative sheet polarizer.

### COMPARATIVE EXAMPLE 2

A sheet polarizer was prepared in the same manner as in Example 5, except that the triacetyl cellulose film used as a protective film was replaced by a 60 μm-thick monoaxially stretched polycarbonate film.

As to the optical characteristics of the polycarbonate film used, the maximum of (nx−ny)×d values and the maximum of {(nx+ny)/2−nz}×d values at wavelengths ranging from 380 nm to 780 nm were 170 nm and 100 nm respectively.

Evaluation of Sheet Polarizers:

Each of the sheet polarizers prepared was evaluated with respect to the following items.

(1) Transmittance

The transmittance of each sheet polarizer was measured with a hazeometer Model 1001 DP (made by Nippon Densiki Kog-yo K.K.).

(2) Efficiency of Polarization

Each polarizer was set on the light source side of the hazeometer Model 1001 DP (made by Nippon Densiki Kogyo K.K.), and examined for transmittance T1 and transmittance T2. Herein, T1 is a transmittance of each sheet polarizer arranged so as to make its transmission axis (the axis lying at right angles to the stretching direction) parallel to the transmission axis of the polarizer, and T2 is a transmittance of each sheet polarizer arranged so as to make its transmission axis (the axis lying at right angles to the stretching direction) perpendicular to the transmission axis of the polarizer. The efficiency of polarization was determined using the following equation:
Efficiency of Polarization (%)={(T1−T2)/(T1+T2)}^{1/2}×100
(3) Number of Chips Stamped Out

Each sheet polarizer was examined as to how many chips measuring 219.0 mm×291.4 mm in size as sheet polarizers for 14.1-inch LCD can be stamped out therefrom. The size of each sheet polarizer was adjusted to the size of the sheet polarizer of Comparative Example 1,650 mm×1,000 mm.

The evaluation results of sheet polarizers prepared in Examples 4 to 6 and those of Comparative Examples 1 to 2 are shown in Table 2.

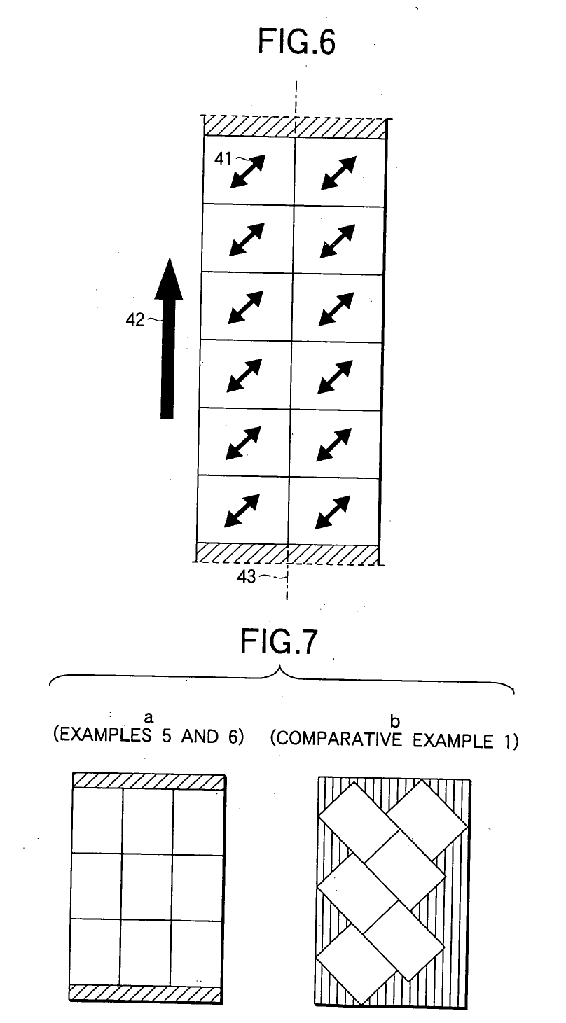

As can be seen from Table 2, the iodine-doped polarization film of Example 4 had high transmittance and high efficiency of polarization. The sheet polarizer of Example 5 was similar in transmittance and slightly inferior in efficiency of polarization to the sheet polarizer of Comparative Example 1, while the sheet polarizer of Example 6 was similar in both transmittance and efficiency of polymerization to the sheet polarizer of Comparative Example 1. Moreover, as shown in FIG. 7, nine chips for 14.1-inch LCD were stamped out from each of the sheet polarizers of Examples 5 and 6. On the other hand, the chips stamped out from the sheet polarizer of Comparative Example 1 was 6 in number. In other words, the yield rates of Examples 5 and 6 were much higher than that of Comparative Example 1. The difference in efficiency of polarization between the sheet polarizers of Examples 5 and 6 was ascribed to the slight difference in birefringence between their substrates.

The sheet polarizer prepared in Comparative Example 2 did not function as sheet polarizer at all because of great birefringence of its substrate.

TABLE 2

| | Transmittance | Efficiency of | Number of Chips |
|---|---|---|---|
| | (%) | Polarization (%) | stamped out |
| Example 4 | 42.8 | 99.98 | — |
| Example 5 | 43.0 | 99.72 | 9 |
| Example 6 | 43.0 | 99.97 | 9 |
| Comparative | 43.1 | 99.96 | 6 |
| Example 1 | | | |
| Comparative | 41.6 | −18.89 | 9 |
| Example 2 | | | |

### EXAMPLE 7

Formation of Wide Viewing Film:

To 30 g of straight-chain alkyl modified polyvinyl alcohol (MP-203, trade name, a product of Kuraray Co., Ltd.), 130 g of water and 40 g of methanol were added, and stirred till the modified polyvinyl alcohol was dissolved therein. The solution obtained was filtered through a polypropylene filter having a pore diameter of 30 μm to prepare a coating solution for an orientation layer.

The coating solution obtained was coated on a 100 μm-thick triacetyl cellulose film (made by Fuji Photo Film Co., Ltd.) having a gelatin thin film (0.1 μm) as subbing layer by means of a bar coater, dried at 60° C., and then subjected to rubbing treatment at an angle of 45 degrees with the machine direction, thereby forming an orientation layer 0.5 μm in thickness.

Then, 1.6 g of Compound LC-1 having the structural formula illustrated below as a liquid crystalline discotic compound, 0.4 g of phenoxydiethylene glycol acrylate (M−101, trade name, a product of Toa Gosei Chemical Industry Co., Ltd.), 0.05 g of cellulose acetate butyrate (CAB531-1, trade name, a product of Eastman Chemical Co., Ltd.) and 0.01 g of a photopolymerization initiator (Irgacure-907, trade name, a product of Ciba Geigy Ltd.) were dissolved in 3.65 g of methyl ethyl ketone, and filtered through a polypropylene filter having a pore diameter of 1 μm, thereby preparing a coating solution for an optically anisotropic layer.

The thus prepared coating solution for an optically anisotropic layer was coated on the orientation layer by means of a bar coater, dried at 120° C., and further heated for 3 minutes for ripening liquid crystals. As a result, the discotic compound was oriented. While keeping it at 120° C., the thus processed coating layer was cured by irradiation with ultraviolet light by the use of a 160 W/cm air-cooled metal halide lamp (made by Ai Graphics Co Ltd.) under a condition that the illumination was 400 mW/cm² and the exposure amount was 300 mJ/cm², thereby forming a 1.8 μm-thick optically anisotropic layer. Thus, a wide viewing film was prepared.

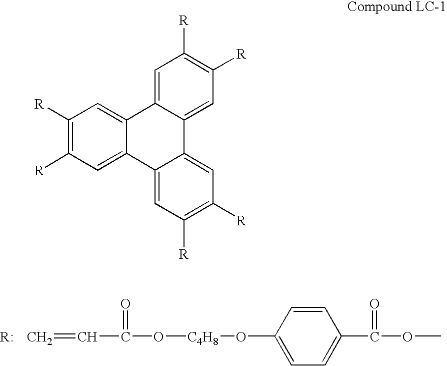

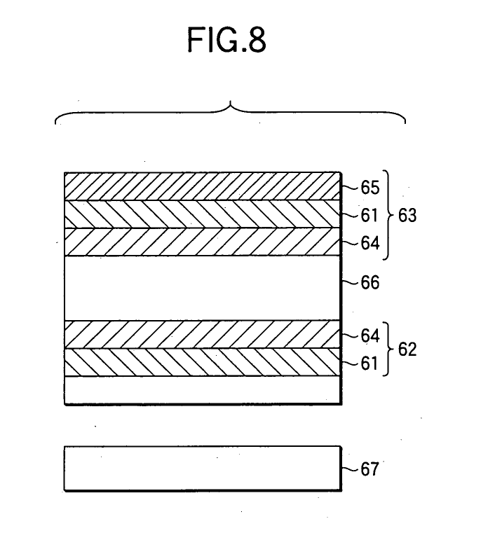

As shown in FIG. 8, a sheet polarizer 62 was prepared in the same manner as in Example 5, except that one of the two protective films for the iodine-doped polarization film 61 was replaced by the wide viewing film 64 prepared above, and the other sheet polarizer 63 was prepared by sticking the wide viewing film 64 on one side of the same iodine-doped polarization film 61 as prepared in Example 5 and a commercially available glare-proof reflection control film 65 (made by Sanritz Co., Ltd.) on the other side of the polarization film 61. Herein, the wide viewing film was stuck so that the rubbing direction of the orientation layer thereof accorded with the stretch direction of the polarization film.

The sheet polarizer 62 was used as one of two sheet polarizers between which a liquid crystal cell 66 of LCD was sandwiched and arranged on the backlight side; while the sheet polarizer 63 was used as the other and arranged on the display side. Herein, the optically anisotropic layer of each wide viewing film was stuck on the liquid crystal cell with an adhesive.

The thus produced LCD exhibited excellent brightness, wide viewing angle characteristics and visibility, and caused no deterioration in display quality even after one-month use at 40° C. under 30% RH.

In accordance with one of the present embodiments, the orientation method utilizing a rubbing treatment instead of a stretching treatment is adopted, and thereby very thin sheet polarizer and a method of producing the sheet polarizer in an improved yield can be provided.

The obliquely stretched polyvinyl alcohol films (including modified ones) and sheet polarizers using them, which are other embodiments of the invention, not only have optical characteristics comparable to commercially available ones, but also realize an increase of yield rate in stamping operation and simplification of the production process to enable a significant reduction of production cost. By utilizing them, liquid crystal displays of high display quality can be prepared at a low cost.

While the invention has been described in detail and with reference to specific embodiments thereof, it will be apparent to one skilled in the art that various changes and modifications can be made therein without departing from the spirit and scope thereof.

What is claimed is:

1. An optical film formed by a method comprising stretching a film comprising a polyvinyl alcohol or a modified polyvinyl alcohol at an oblique angle ranging from 10 to 80 degrees to the machine direction of the film.
